(19) United States
(12) Patent Application Publication
(10) Pub. No.: US 2018/0303183 A1
(43) Pub. Date: Oct. 25, 2018

(54) WOOD BRIMMED CAP METHOD AND DEVICE

(71) Applicants: JEFFREY BRANDT, FORT WORTH, TX (US); RACHEL BRANDT, FORT WORTH, TX (US)

(72) Inventors: JEFFREY BRANDT, FORT WORTH, TX (US); RACHEL BRANDT, FORT WORTH, TX (US)

(21) Appl. No.: 15/960,491

(22) Filed: Apr. 23, 2018

Related U.S. Application Data
(60) Provisional application No. 62/488,447, filed on Apr. 21, 2017.

(51) Int. Cl. A42B 1/02; B32B 37/12; B32B 21/04

(52) U.S. Cl. CPC A42B 1/02; B32B 2437/04; B32B 21/042; B32B 37/12

(57) ABSTRACT

A wood brimmed cap includes a rigid brim, a brim attachment member and a head covering. The brim is composed of a plurality of layers of a rigid material, such as wood. The brim includes a recess for attachment of a portion of the brim attachment member. The recess is covered by a bottom layer of the brim. The brim attachment member and the head covering are stitched and/or adhesively bonded to the brim.

### CLAIM OF PRIORITY

This application claims the benefit of U.S. Provisional Application No. 62/488,447, filed 21 Apr. 2017. The information contained therein is hereby incorporated by reference.

### BACKGROUND

### 1. Field of the Invention

The present application relates to an improved hat, and more particularly to a method and device for generating a hat having a wood brim with optional curvature.

### 2. Description of Related Art

Headwear, particularly, “ball caps” are very popular. These are worn by people of no particular age, race, or demographic. They are popular particularly with sports related teams (i.e. baseball) but are used to promote and advertise any company, legal entity, or other message, phrase, and picture. They are often referred to as baseball caps as they are worn by baseball players as part of their uniform and is where they gained a large part of their popularity.

Traditionally these ball caps consist of a head covering section that has a front panel, a sweat band piece, and a bill. The front panel is where graphics, words, and other messaging is located traditionally. Locating it here allows it to be visible when worn in a forward manner. Some graphics, words, or messaging may be located in other sections of the head covering as well (i.e. the back or sides). The sweat band typically runs around the lower area of the hat and provides some comfort to the wearer and absorbs the sweat. The bill is located adjacent the sweat band and protrudes outward from the front panel. Generally these are made from foldable or malleable material to allow the user to bend and shape it to a set contour. A disadvantage of traditional bills is that they tend to not hold their shape over time and get squished, thereby losing their shape.

Although strides have been made to provide a better headwear, shortcomings remain. It is desired that a wood brimmed cap be provided that maintains its shape.

### SUMMARY OF THE INVENTION

It is an object of the present application to provide a headwear cap that includes a layered wood bill. The bill is composed of layered wood members that are bonded or adhered together. A brim attachment member is partially adhered between the layers of wood. Stitching is performed to help coupled a head covering portion and the brim attachment member into the wood brimmed bill. The brim attachment member is stitched to the perimeter of the head covering portion. Ultimately the invention may take many embodiments, such as three or more layers of wood and configurations including a flat bill and a curved bill. In this way, this assembly overcomes the disadvantages inherent in the prior art.

The more important features of the device have thus been outlined in order that the more detailed description that follows may be better understood and to ensure that the present contribution to the art is appreciated. Additional features of the device will be described hereinafter and will form the subject matter of the claims that follow.

Many objects of the present device will appear from the following description and appended claims, reference being made to the accompanying drawings forming a part of this specification wherein like reference characters designate corresponding parts in the several views.

Before explaining at least one embodiment of the device in detail, it is to be understood that the device is not limited in its application to the details of construction and the arrangements of the components set forth in the following description or illustrated in the drawings. The device is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the various purposes of the present device. It is important, therefore, that the claims be regarded as including such equivalent constructions insofar as they do not depart from the spirit and scope of the present device.

### DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a perspective view of a wood brimmed cap according to an embodiment of the present application.

FIG. 2 is a rear perspective view of the wood brimmed cap of FIG. 1.

FIG. 3 is a front view of an alternative embodiment of the wood brimmed cap of FIGS. 1 and 2.

FIG. 4 is a top view of a brim attachment member in the wood brimmed cap of FIG. 1.

FIG. 5 is an exemplary perspective view of the assembly of a portion of a wood brim in the wood brimmed cap of FIG. 1.

FIG. 6 is a side view of the wood brim of FIG. 5.

FIG. 7 is a bottom view of the wood brim of FIG. 6.

FIG. 8 is a top view of the wood brim of FIG. 8 and a head covering of FIG. 1.

FIG. 9 is a bottom view of the wood brim from FIG. 7 and the brim attachment member of FIG. 4.

FIG. 10 is a side view of the wood brimmed cap of FIG. 9.

FIG. 11 is a side view of the wood brimmed cap of FIG. 9 with a finishing member.

FIG. 12 is a chart of the method of making the wood brimmed cap of FIGS. 1 and 3.

While the assembly and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE PREFERRED EMBODIMENT

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

The device and method in accordance with the present application overcomes one or more of the above-discussed problems commonly associated with conventional caps discussed previously. In particular, the wood brimmed cap device uses a layered wooded brim in place of a flexible material. The brim is hardened and bonded together to maintain rigidity and shape. The brim is configured to maintain a tasteful appearance by layering a lower finishing member of wood beneath the brim attachment member and initial layered brim members. The wooden brim is configured to couple to a head covering and may be constructed to have a flat contour or a curved contour. These and other unique features of the assembly are discussed below and illustrated in the accompanying drawings.

The device and method will be understood, both as to its structure and operation, from the accompanying drawings, taken in conjunction with the accompanying description. Several embodiments of the device may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The device and method of the present application is illustrated in the associated drawings. The wood brimmed cap device includes a layered brim made from one or more rigid materials. The layers of the brim are adhered together. A brim attachment member is configured to be adhered to the layers of the brim and fold upward along the inside of the brim so as to protect the head of a wearer. The brim attachment member is sandwiched between layers of the layered brim. The head covering is stitched to the brim and into the brim attachment member. Additional features and functions of the device are illustrated and discussed below.

Referring now to the Figures wherein like reference characters identify corresponding or similar elements in form and function throughout the several views. The following Figures describe the device of the present application and its associated features. With reference now to the Figures, an embodiment of the modular observation assembly and method of use are herein described. It should be noted that the articles “a”, “an”, and “the”, as used in this specification, include plural referents unless the content clearly dictates otherwise.

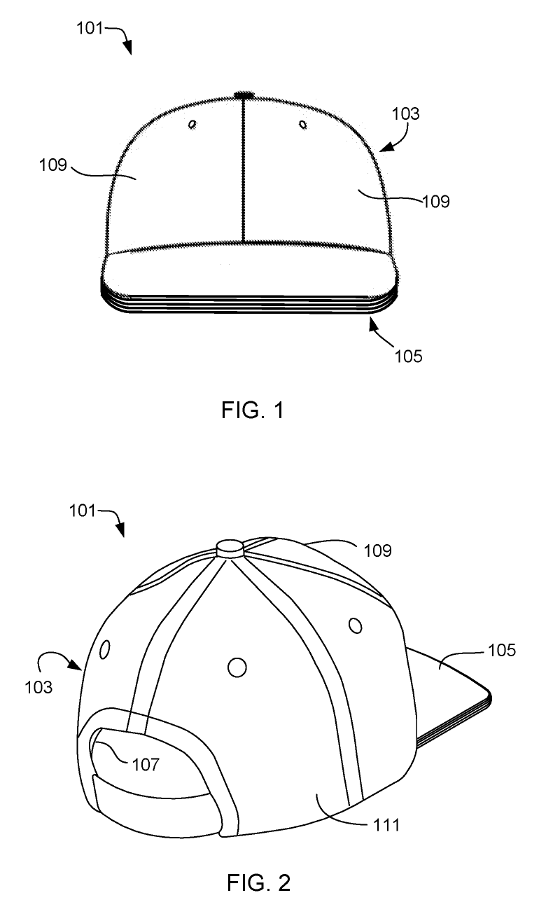

Referring now to FIGS. 1 and 2 in the drawings, perspective views of a wood brimmed cap device is illustrated. Wood brimmed cap device 101 includes a head covering portion 103, a brim 105 and a brim attachment member 107. Head covering portion 103 is configured to form a concaved shaped opening that fits around a head of a wearer. Portion 103 may include a front panel 109 and a covering 111. Panel 109 is where a predominant amount of graphical, textual, and messaging occurs on device 101. Other sides and sections of portion 103 can support such content.

Of particular note in device 101 is the combination of member 107 and brim 105 and its association with covering 103. Device 101 of the present application is configured to include a multi-layered brim 105. Brim 105 is formed from a number of layers of rigid materials. Each layer may be composed of one or more materials and combinations thereof. The separate layers and secured together in a particular manner in combination with member 107 and covering 103. The material for brim 103 is preferred to be a softer wood, such as Birch, and may include a filler material between the outer visible layers of wood. The inner layers may be different from the materials of the layers exposed on the upper most and lowest sides of brim 105. Other materials besides wood are permitted and not limited to the materials herein used to describe the process and device. Device 101 will be described as using a brim with wood layers.

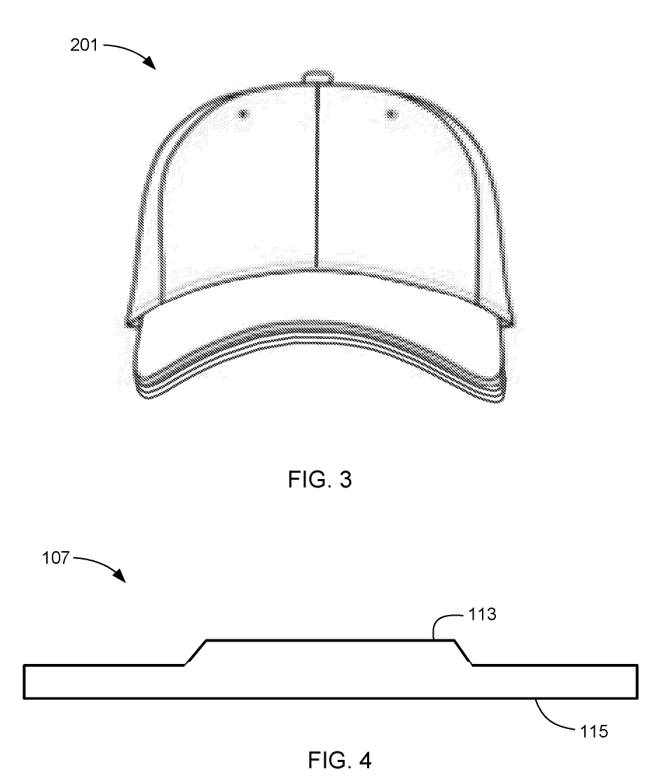

Referring now also to FIG. 3 in the drawings, an alternative embodiment of device 101 is illustrated. Wood brimmed cap device 201 is similar in form and function to that of device 101 except as herein states. Device 201 includes a wood brim that is constructed to have a curved or rounded contour as depicted. In device 101, brim 105 is flat. The steps of making the brims of device 101 and device 201 are similar. The various steps and techniques are used to ensure a proper combination of materials to form device 101 and 201.

Referring now also to FIG. 4, a top view of a brim attachment member 107 is illustrated. Member 107 is composed of one or more pieces of one material, cloth, leather, fabric, and so forth. One or more layers may be organized to provide additional comfort and function. Member 107 is configured to line the inside of device 101 and contact the head of a wearer. Member 107 acts as a sweat band and provides comfort to the wearer. Member 107 is depicted in FIG. 4 as being a single unitary piece of material. In this case a leather material is chosen, although not meant to be restricting. Member 107 includes a brim portion 113 and a band portion 115. Brim portion 113 is coupled between layers of brim 105 and band portion 115 is folded internally along an inside portion of covering 103 to separate a wearer's head from brim 105.

In situations where member 107 is made from different materials, it is understood that portion 113 and portion 115 may be separate pieces of material and need to be joined. When this occurs, top edges of each are lined up and against a template where they are sewn along the large edge of portion 113 to a long edge of portion 115. Other folds and stitching may be performed to shape and combine the materials as needed to form member 107 seen in FIG. 4. It is understood that maintaining a singular material and cutting out a singular member 107 is greatly simplified and preferred.

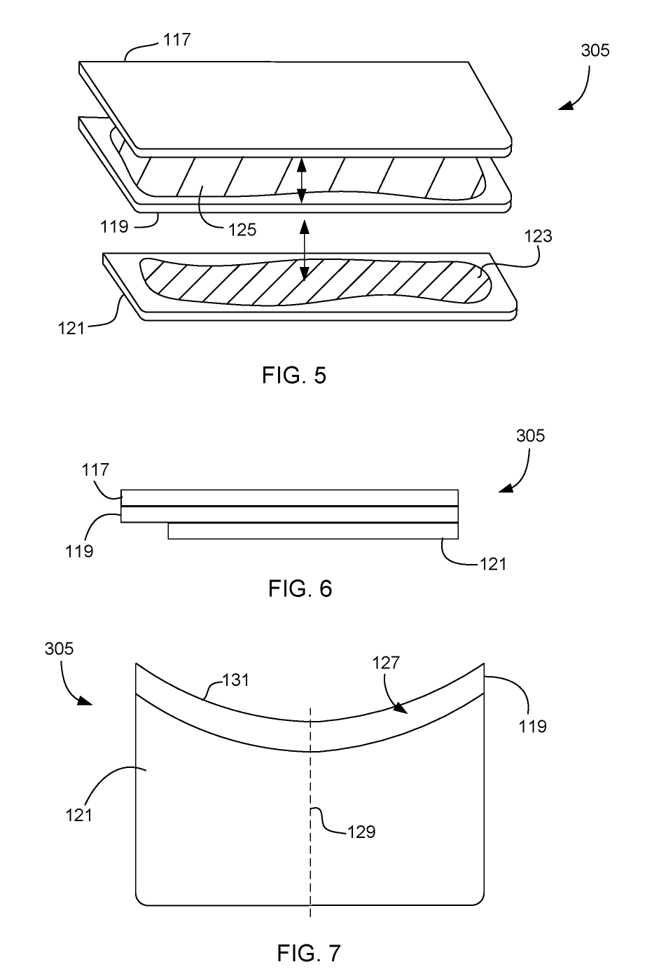

Referring now also to FIGS. 5-7 in the drawings, views showing the formation of brim 105 are illustrated. As stated previously, brim 105 is composed of a plurality of layers. As seen in the Figures, a total of four layers are illustrated and described. It is known that three or more layers are possible. The thickness of the layers may be different between them. Additionally, the materials of each of the layers may differ between them. As seen in FIG. 5, brim 105 includes an upper layer 117, full inner layer 119, and short inner layer 121. Each of these are bonded or coupled together with an adhesive 123/125. The adhesives may differ depending on the materials and surface finishes of each layer member. Layer 121 is shorter in depth compared to layers 117 and 119 so as to create a recess 127 for acceptance of member 107, and in particular to brim portion 113.

In operation, two pieces of thin brim-shaped material (such as veneer, sourced by routing or laser-cutting using template) are acquired and a thin layer of adhesive 125 is applied (such as wood glue) on a surface of layer 119 for attachment of layers 117 and 119. The layers are lined up and pressed together. This may occur best in a mold or press. The layers are lined up and pressed to bond the adhesive-covered finished side to non-adhesive-covered unfinished side of the other piece. This process is repeated for the combined layers 117/119 and that of layer 121. A thin layer of adhesive is applied to a surface of layer 121, and layer 121 is then press against a lower surface of layer 119. Layer 121 is aligned along the front edge of brim 105 so as to create recess 127 at the back edge. As seen in FIG. 7, a bottom view of the combined three layers of brim 105 are shown (Brim 305).

Brim 305 is a partial constructed assembly of brim 105 wherein the short layer 121 is only bonded on a singular side to opposing layers. In this configuration, recess 127 is visible. Centerline 129 is illustrated and forms a center marking location for alignment of covering 103 on brim 301 and is the point of flexure for the curved brim configuration seen in FIG. 3. It is worth noting that FIG. 5 is a representation of the layers in brim 105 in that the curved back edge is omitted from the figure (as seen in FIG. 7). The curved back edge is needed to contour around the head of a wearer. Along any of the bonding steps with adhesive, the layers may be placed into a mold or shaped press to allow for the adhesive to cure.

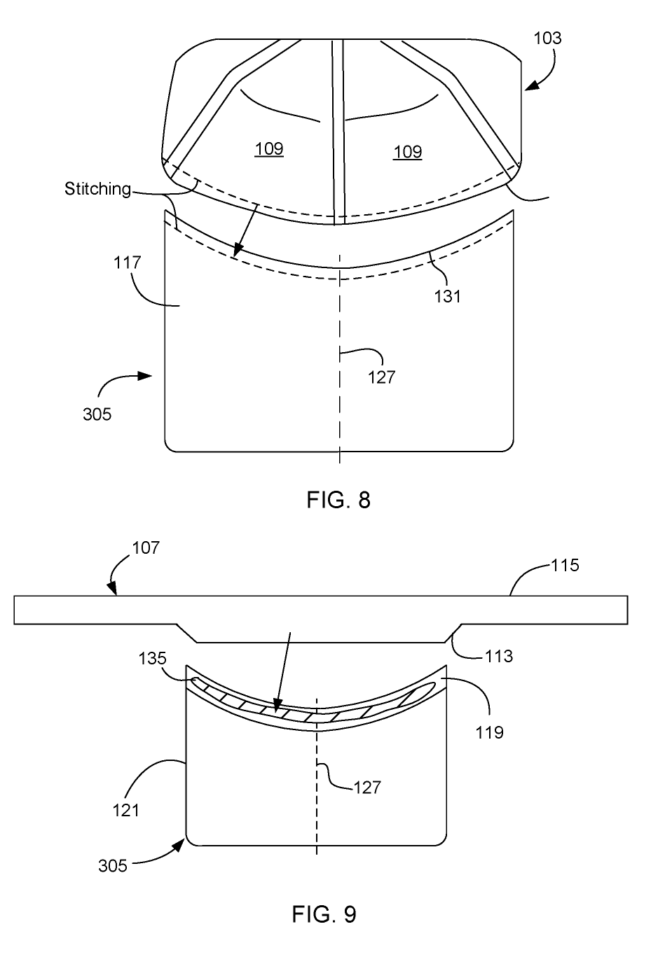

Referring now also to FIGS. 8 and 9 in the drawings, views illustrating the attachment of covering 103 to brim 305 and member 107 to brim 305 are provided. As seen in FIG. 8, covering 103 is coupled to brim 305. After the head covering 103 is fully constructed, it is ready to be attached to the brim 305. The attachment process is the same for the curved and flat brim devices.

A mark (i.e. middle) on both the brim and panel 109 are made and both are tacked together at that mark. The mark may coincide with centerline 129. Tacking may be done by applying a small dot of adhesive (such as hot glue) on the mark made on the brim and pressing the covering 103 to the adhesive such that the marks on each are aligned. Tacking is configured to hold the two pieces together until sewn.

Panel 109 is sewn or stitched to brim 305 adjacent back edge 131 one side at a time, starting from the center of the brim 305 at centerline 129, and moving to outward edges to the left and right. In FIG. 8, a top surface of brim 305 is seen. Dashed lines represent the area where stitching occurs between edge 133 of panel 109 and brim 305.

In FIG. 9, a lower view of brim 305 is shown along with member 107. Brim portion 113 is coupled to recess 127 with an adhesive 135. As member 107 is flexible, any necessary shaping needed to fit the contour of recess 127 is possible. Adhesive 135 may be similar to that of adhesives 123 and 125, or that which was used to tack covering 103 to the upper side of brim 305.

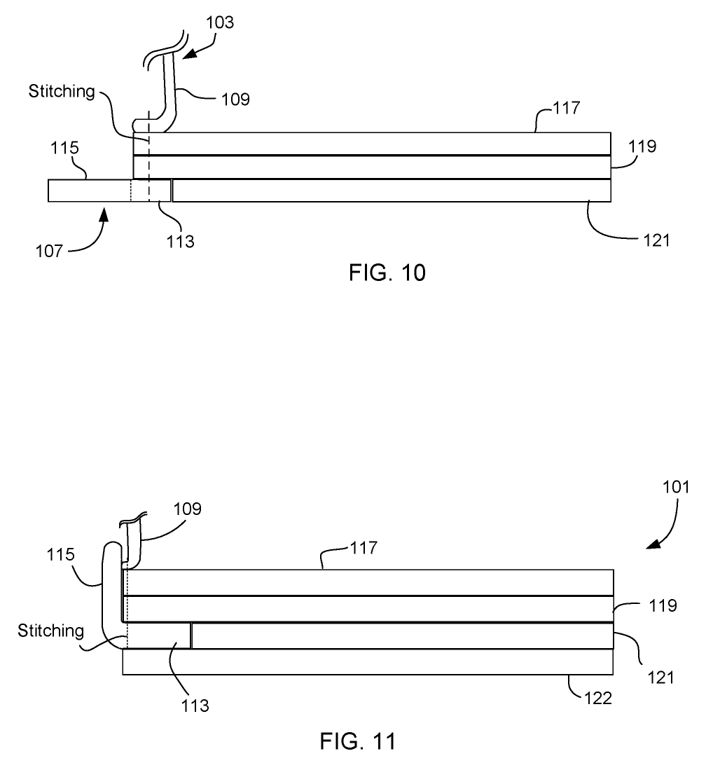

Referring now also to FIG. 10 in the drawings, a side view of brim 305 with covering 103 and member 107 is illustrated. After portion 113 is sewn onto brim 305 at recess 127, member 107 and covering 103 are stitched together along a lower edge about the circumference of the covering 103. Stitching begins at the corners of brim 305 and continues until the rest of the sweatband is sewn. Stitching may pass through covering 103, brim 305 and member 107 at the corners to help ensure a clean and strong coupling.

Referring now also to FIG. 11 in the drawings, a side view of brim 105 is illustrated. After member 107 and covering 103 are coupled, recess 127 and brim portion 113 may be covered to provide a clean finished edge. Layer 122 is coupled to an exposed side of layer 121 in a process similar to that of the bonding of layers 117, 119, and 121 together above. The adhesive is similar to adhesive 123 and 125. The lower layer is a finishing layer 122 where the front edge is aligned with the front edge of brim 305. A press or mold may be used to contour layer 122 to the same contour of brim 305. Layer 122 is configured to cover recess 127 and band portion 113 and align with back edge 131.

It is understood that the description provided herein in combination with the Figures applies equally to device 201 as it does device 101. Additionally, the stitching seen in FIGS. 10 and 11 is used to illustrate the stitching done to couple member 107 and covering 103 at the corners of brim 305. Furthermore, adhesive is illustrated distributed about various surfaces of device 101. It is understood that the adhesives may be distributed about entire surfaces or any portion of such surfaces as needed to facilitate proper bonding.

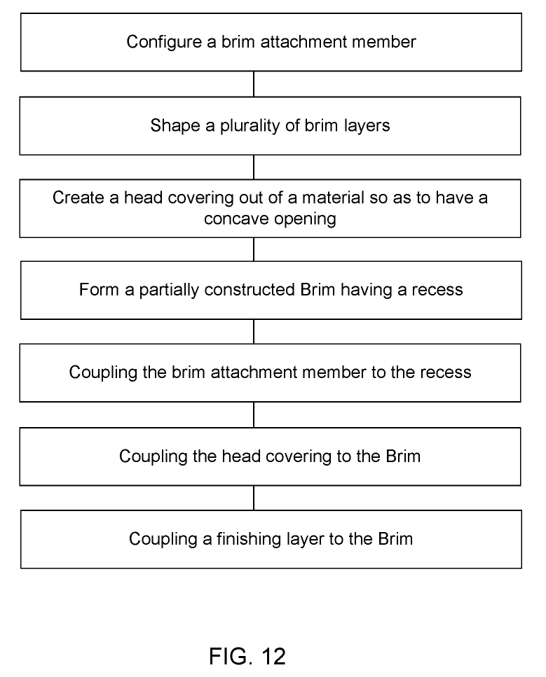

Referring now also to FIG. 12, a chart of the method of making device 101 is illustrated. The steps are provided in the description above and include the following. A brim attachment member is configured from one or more pieces of material. It may be cut out as a singular member or stitched together from multiple materials. The brim layers are shaped and sized in accordance with the size of the brimmed cap device. A head covering is created out of a material so as to have a concave opening for the fitting of a wearer's head. The brim is partially constructed by bonding layers of the brim together. The partially constructed brim includes a recessed area either formed from a cutting tool after bonding of the layers or by bonding a lower internal layer that is shorter than the other layer. The brim attachment member is coupled to the recessed area of the brim. The head covering is coupled to the brim at an upper surface. Both the brim attachment member and the head covering are coupled together via stitching both at the brim and outside of the brim. A finishing layer of the brim is bonded to cover the recessed area.

The current application has many advantages over the prior art including at least the following: (1) a rigid brim; (2) a clean and comfortable finish by incorporating the brim attachment member between layers of the brim; (3) curved and flat contoured brims; and (4) stitching the head covering to the brim attachment member through the brim.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. A method of making a brimmed cap, comprising:
configuring a brim attachment member;
shaping a brim having a plurality of brim member layers;
creating a head covering having a concave shape;
layering a plurality of brim member layers, the plurality of brim member layers coupled together via an adhesive;
forming a recess along a back edge of the brim;
coupling the brim attachment member to the recess;
coupling the head covering to the brim; and
coupling a finishing layer to the brim attachment member and the plurality of brim member layers so as to cover the recess.

2. The method of claim 1, wherein the recess is formed from a smaller internal brim member layer.

3. The method of claim 1, wherein the recess is formed by routing the back edge of the brim.

4. The method of claim 1, wherein the brim attachment member is stitched to the brim.

5. The method of claim 1, wherein the brim attachment member is glued to the brim.

6. The method of claim 1, wherein the head covering is stitched to the brim.

7. The method of claim 6, wherein the head covering is stitched to the brim outward from a centerline.

8. The method of claim 1, wherein the brim attachment member is stitched to the head covering.

9. The method of claim 8, wherein the brim attachment member and the head covering are stitched across a portion of the brim.

10. The method of claim 1, wherein the plurality of brim member layers are coupled with an adhesive.

11. The method of claim 1, wherein the plurality of brim member layers are shaped prior to coupling them together.

12. The method of claim 1, wherein the plurality of brim member layers are shaped at the time of bonding the layers together.

13. The method of claim 1, wherein the brim is made from a plurality of wood brim member layers.

14. The method of claim 1, wherein the brim member layers are different from one another.

15. The method of claim 1, wherein the brim member layers are made from the same material.

16. A brimmed cap, comprising
a rigid brim having a plurality of layers bonded together, the plurality of layers forming a recess;
a head covering having a concave opening; and
a brim attachment member coupled to the head covering and the rigid brim;
wherein the brim attachment member is inserted into the recess in the rigid brim.

17. The cap of claim 16, wherein the plurality of layers of the brim are made from the same material.

18. The cap of claim 16, wherein the plurality of layers of the brim are made from at least two different materials.

19. The cap of claim 16, wherein the brim attachment member is stitched to the brim.

20. The cap of claim 16, wherein the head covering is stitched to the brim.
